(19) United States
(12) Patent Application Publication
(10) Pub. No.: US 2026/0013411 A1
(43) Pub. Date: Jan. 15, 2026

(54) MULTIFUNCTIONAL TRACTOR EQUIPMENT ATTACHMENT

(71) Applicant: LDS Holdings LLC, DBA ProEnclosures, Milton, KY (US)

(72) Inventors: Shane APPLEGATE, Milton, KY (US); Derrick Shelley, Milton, KY (US); Justin Vanover, Milton, KY (US)

(21) Appl. No.: 19/269,145

(22) Filed: Jul. 15, 2025

Related U.S. Application Data
(60) Provisional application No. 63/671,361, filed on Jul. 15, 2024.

(51) Int. Cl. A01B 59/06

(52) U.S. Cl. CPC A01B 59/06

(57) ABSTRACT

This disclosure provides multifunctional tractor equipment attachments having a frame with a backside that faces a tractor. On the backside of the frame are tractor connector mounts. On the side of the frame that is facing away from the tractor (the front side) is a bale spear bushing. A tow hitch is attached to the bottom of the frame. A fork attachment bar is attached to the bottom of the tow hitch. Toward each end of the fork attachment bar or directly on the end of fork attachment bar, rotatably forks are a mounted. The forks are arranged so that in an extended position they face horizontally. In a retracted position, the tip of the forks (which may be slanted) points to the sky, i.e., vertically.

### CROSS-REFERENCE TO RELATED APPLICATION

This application claims priority to U.S. Provisional Application 63/671,361 (filed on Jul. 15, 2024) which is incorporated by reference in its entirety.

### FIELD OF THE INVENTION

This disclosure is directed to a multifunctional tractor equipment attachment that attaches to three-point mounts on tractors.

### BACKGROUND OF THE INVENTION

Tractors have mounts at their back that allows for the attachment of various agricultural tools depending on the season, type of crop etc. However, especially for smaller farms, such as hobby farms, it is cumbersome and often prohibitively expensive to buy multiple tools that only have a limited use.

What is therefore needed is a multifunctional tractor equipment attachment that has the function of more than one agriculture tool thereby reducing the need to buy and store multiple pieces of equipment.

### SUMMARY OF THE INVENTION

This disclosure provides multifunctional tractor equipment attachments. The multifunctional tractor equipment attachments generally have a frame which has a backside that faces a tractor and that include tractor connector mounts. On the side of the frame that is facing away from the tractor is a bale spear bushing. A tow hitch is attached to the bottom of the frame. A fork attachment bar is attached to the bottom of the tow hitch. Toward each end of the fork attachment bar or directly on the end of fork attachment bar, rotatably forks are a mounted. The forks are arranged so that in an extended position they face horizontally (i.e., point away from the tractor). In a retracted position, the tip of the forks (which may be slanted) points to the sky, i.e., vertically.

One embodiment of the disclosure is a multifunctional tractor equipment attachment having: a rectangular shaped attachment frame having a front side, a backside, a horizontal top piece and a parallel horizontal bottom piece connected by vertical connectors positioned toward each end of the parallel horizontal bottom piece; a tow hitch receiver connected to the horizontal bottom piece outside the rectangular shaped attachment frame having a front side for receiving a ball mount and a backside; a fork attachment bar connected to the tow hitch receiver and parallel to the horizontal bottom piece with a pair of front facing forks mounted on the fork attachment bar, each fork attached towards a different end of the fork attachment bar; a bale spear bushing releasably mounted on approximately the middle of horizontal top piece, the bale spear bushing positioned on the inside of the rectangular shaped attachment frame and facing the front side of the rectangular shaped attachment frame; an upper draw pin mount facing the backside of the rectangular shaped attachment frame mounted on the horizontal top piece opposite to the bale spear; a pair of grab hooks mounted parallel on the vertical connectors positioned on the vertical connectors in line with the bale spear bushing; and a pair of tractor connector mounts mounted parallel on the vertical connectors facing the backside of the rectangular shaped attachment frame.

In certain embodiments, the interior of the attachment frame is square shaped. In some embodiment, the horizontal top piece extends beyond the ends of the square. In other embodiments, the tow hitch receiver has a pair of holes for holding a pin for holding a ball mount. These holes may be positioned on the backside of the attachment frame.

In some embodiments, the fork attachment bar has a connector connecting the bar and the parallel horizontal bottom piece.

In certain embodiments, the bale spear bushing is mounted on the middle of the horizontal top piece via a bale spear bushing mount. In other embodiments, the bale spear bushing mount is capped. In additional embodiments, the attachment includes front facing forks each attached to an end of the fork attachment bar. In some embodiments, the front facing forks are foldable with a closed position parallel to the vertical connectors and an open position facing the front. In other embodiments, the front facing forks are hinged.

Another embodiment of the disclosure is a multifunctional tractor equipment attachment having: a rectangular shaped attachment frame having a front side, a backside, a horizontal top piece and a parallel horizontal bottom piece connected by parallel vertical connectors positioned toward each end of the parallel horizontal bottom piece; a tow hitch receiver connected to the horizontal bottom piece outside the rectangular shaped attachment frame having front side configured for receiving a ball mount and a backside; a fork attachment bar connected to the tow hitch receiver and parallel to the horizontal bottom piece with a pair of front facing forks mounted on the bar, the pair of forks rotatably attached towards each end of the fork attachment bar; a bale spear bushing releasably mounted on approximately the middle of horizontal top piece, the bale spear bushing positioned on the inside of the rectangular shaped attachment frame and facing the front side of the rectangular shaped attachment frame; an upper draw pin mount facing the backside of the rectangular shaped attachment frame mounted on the horizontal top piece opposite to the bale spear; a pair of grab hooks mounted parallel on the vertical connectors positioned on the vertical connectors in line with the bale spear bushing; and a pair of tractor connector mounts mounted parallel on the vertical connectors facing the backside of the rectangular shaped attachment frame.

In some embodiments, the pair of forks is configured to rotate from a closed position parallel to the vertical connectors to an open position facing the front side. In another embodiment, each fork has an angled front end and a back end that is rotatably attached toward each end of the fork attachment bar. In an alternate embodiment, the back end of each fork is attached via a hinge.

In some embodiments, in a closed position, the angled front end of each fork is parallel to the vertical connectors. In other embodiments, in an open position, the angled front end of each fork extends away from the front end of the rectangular shaped attachment frame.

Other features and advantages of the invention will be apparent from the detailed description and examples that follow.

### BRIEF DESCRIPTION OF THE DRAWINGS

The foregoing summary, as well as the following detailed description of the invention, will be better understood when read in conjunction with the appended figures. For illustrating the invention, the figures demonstrate embodiments of the present invention. It should be understood, however, that the invention is not limited to the precise arrangements, examples, and instrumentalities shown.

FIG. 1A shows a front view of a multifunctional tractor equipment attachment according to one embodiment of the disclosure.

FIG. 1B shows another front view of a multifunctional tractor equipment attachment according to one embodiment of the disclosure with forks that attach to the attachment.

FIG. 1C shows a top view of a multifunctional tractor equipment attachment according to one embodiment of the disclosure.

FIG. 2A shows a back view of a multifunctional tractor equipment attachment according to one embodiment of the disclosure.

FIG. 2B shows a back view of a multifunctional tractor equipment attachment according to one embodiment of the disclosure with the backplate in place.

FIG. 3 shows a side view of a fork according to one embodiment of the disclosure.

FIG. 4A shows an image of a front view of a multifunctional tractor equipment attachment according to one embodiment of the disclosure.

FIG. 4B shows an image of a front view of a multifunctional tractor equipment attachment according to one embodiment of the disclosure with the backplate in place.

### DETAILED DESCRIPTION

This disclosure provides multifunctional tractor equipment attachments. The multifunctional tractor equipment attachments of the disclosure generally have a frame which has a backside that faces a tractor and a frontside that includes a bale spear bushing, forks, and a trailer hitch.

The general description and the following detailed description are exemplary and explanatory only and are not restrictive of the invention, as defined in the appended claims. Other aspects of the present invention will be apparent to those skilled in the art in view of the detailed description of the invention as provided herein.

For clarity of disclosure, and not by way of limitation, the detailed description of the invention is divided into subsections that describe or illustrate certain features, embodiments, or applications of the present invention.

### Definitions

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods, and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates, which may need to be independently confirmed.

It is noted that, as used herein and in the appended claims, the singular forms “a,” “an,” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As used herein, the term “about” when referring to a measurable value such as an amount, a temporal duration, and the like, is meant to encompass variations of +20% or +10%, more preferably +5%, even more preferably +1%, and still more preferably +0.1% from the specified value, as such variations are appropriate to perform the disclosed methods.

It is also to be understood that the terminology used herein is for the purpose of describing particular embodiments only and is not intended to be limiting.

As used herein, the terms “comprising,” “including,” “containing” and “characterized by” are exchangeable, inclusive, open-ended and do not exclude additional, unrecited elements or method steps. Any recitation herein of the term “comprising,” particularly in a description of components of a composition or in a description of elements of a device, is understood to encompass those compositions and methods consisting essentially of and consisting of the recited components or elements.

Throughout this specification, unless the context requires otherwise, the word “comprise” or variations such as “comprises” or “comprising”, will be understood to imply the inclusion of a stated integer or group of integers but not the exclusion of any other integer or group of integers.

As used herein, the term “consisting of” excludes any element, step, or ingredient not specified in the claim element.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

It is also to be understood that the terminology used herein is for the purpose of describing particular embodiments only and is not intended to be limiting.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. Before certain embodiments are described in greater detail, it is to be understood that this invention is not limited to certain embodiments described, as such may, of course, vary. It is also to be understood that the terminology used herein is for the purpose of describing certain embodiments only, and is not intended to be limiting, since the scope of the present invention will be limited only by the appended claims.

Before certain embodiments are described in greater detail, it is to be understood that this invention is not limited to certain embodiments described, as such may, of course, vary. It is also to be understood that the terminology used herein is for the purpose of describing certain embodiments only, and is not intended to be limiting, since the scope of the present invention will be limited only by the appended claims.

### Multifunctional Tractor Equipment Attachments

This disclosure provides multifunctional tractor equipment attachments. The multifunctional tractor equipment attachments of the disclosure generally have a frame which has a backside that faces a tractor. On the backside of the frame are tractor connector mounts. On the side of the frame that is facing away from the tractor (the front side) is a bale spear bushing. A tow hitch is attached to the bottom of the frame. A fork attachment bar is attached to the bottom of the tow hitch. Toward each end of the fork attachment bar or directly on the end of fork attachment bar, rotatably forks are a mounted. The forks are arranged so that in an extended position they face horizontally. In a retracted position, the tip of the forks (which may be slanted) points to the sky, i.e., vertically.

The attachment frame is generally rectangular, although it can also be a square. The top of the attachment frame can be slightly longer than the bottom. In certain embodiments, the top of the attachment frame is dimensioned such that the ends of the top of the attachment frame almost touch the folks in the folded position.

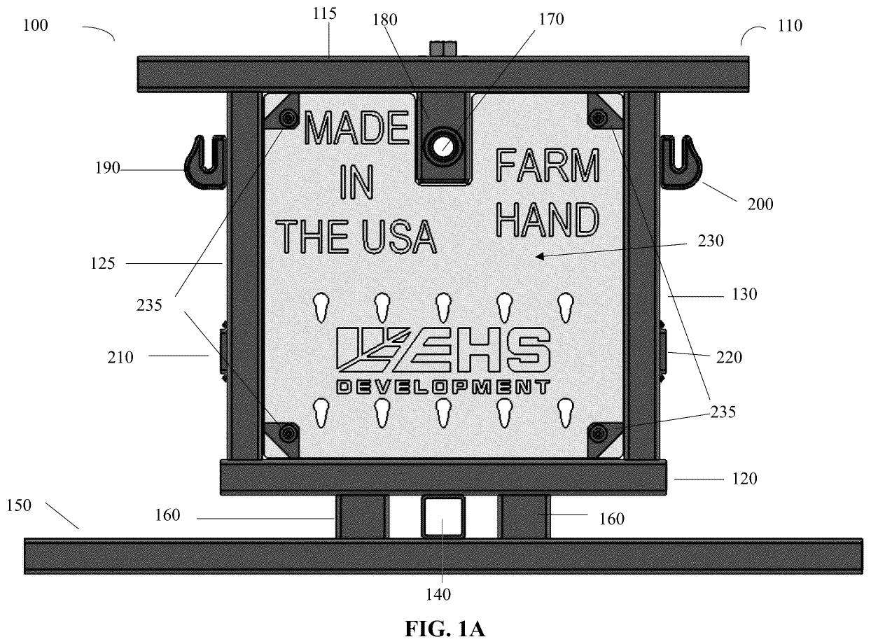

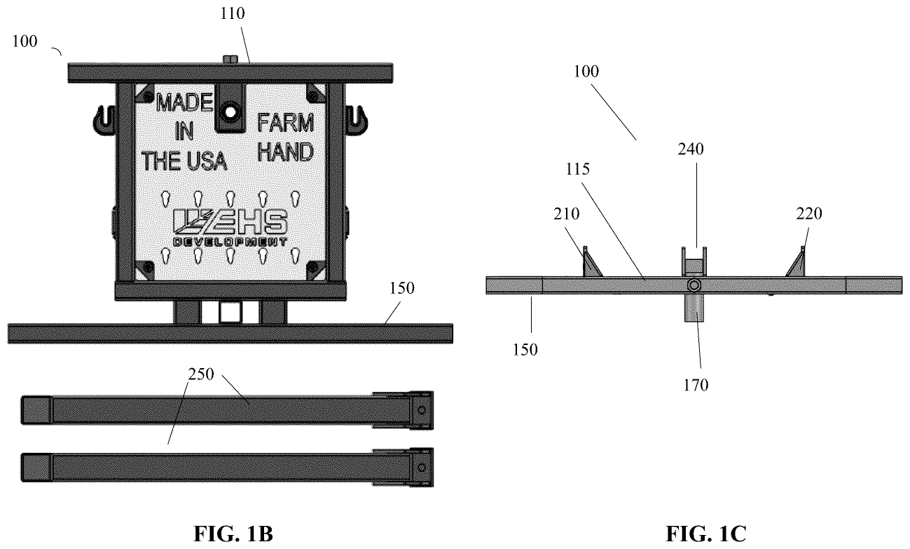

FIG. 1A shows a front view of a multifunctional tractor equipment attachment 100 according to one embodiment of the disclosure. The front view shown in FIG. 1A faces away from the tractor to which the multifunctional tractor equipment attachment 100 is attached via connections on the backside.

As shown in FIG. 1A, multifunctional tractor equipment attachment 100 has attachment frame 110 which has a horizontal top piece 115, a horizontal bottom piece 120, a vertical connector 125, and a vertical connector 130. The attachment frame is rectangular shaped with the horizontal top piece 115, horizontal bottom piece 120, vertical connector 125, and vertical connector 130 defining the sides of the rectangle. Horizontal top piece 115 and horizontal bottom piece 120 are arranged parallel to each other.

The vertical connector 125 and vertical connector 130 connect the horizontal top piece 115 and horizontal bottom piece 120. In certain embodiments, the vertical connector 125 and vertical connector 130 are parallel to each other. In other embodiments, the vertical connector 125 and vertical connector 130 are parallel to each other and perpendicular to the horizontal top piece 115 and horizontal bottom piece 120.

The attachment frame 110 is rectangular shaped. In certain embodiments, the attachment frame is a square or approximately square shaped. The attachment frame can be constructed of about 2×2 inch metal with a 0.250 inch thick wall.

A tow hitch 140 is attached to horizontal bottom piece 120. The tow hitch 140 is positioned approximately centered or alternatively centered on the horizontal bottom piece 120. In certain embodiments, the front of the tow hitch that accept the faces away from the front of the attachment frame 110. Tow hitch 140 is configured to accept trailer ball mount 145 (not shown). The tow hitch 140 also has a pair of holes for a pin for holding the trailer ball mount 145 (not shown).

Fork attachment bar 150 is attached at the bottom of tow hitch 140 and arranged to be parallel to the attachment frame 110, horizontal top piece 115, and horizontal bottom piece 120. Toward cither end of fork attachment bar 150, a front facing fork 250 is attached. In some embodiments, a front facing fork 250 is attached to either end of the fork attachment bar 150.

The front facing fork 250 is configured to fold. In certain embodiments, the front facing fork 250 is hingedly mounted on the fork attachment bar 150. In some embodiments, the front facing fork 250 includes pins to hold hinges. The front facing fork 250 can be releasably mounted. The front facing fork 250 is arranged so that in an extended position the front facing fork 250 faces away from the attachment frame 110. In other words, the front facing fork 250 is arranged to be vertical to attachment frame 110 extending away from the tractor.

The horizontal top piece 115 can be longer than the horizontal bottom piece 120, i.e., the ends of horizontal top piece 115 extend beyond the ends of horizontal bottom piece 120. In certain embodiments, the horizontal top piece 115 is configured so that its slightly shorter than fork attachment bar 150 such as not to interfere with the movement of the front facing fork 250.

In certain embodiments, one or more connector 160 connect the bottom of horizontal bottom piece 120 with the top of the fork attachment bar. The connector can be rectangular shaped. In some embodiments, the connector 160 is sized so as not to protrude beyond the front and backside of the attachment frame.

Bale spear bushing 170 is positioned toward the top of attachment frame 110 and approximately centered on horizontal top piece 115. The bale spear bushing 170 is preferably positioned on the inside of the attachment frame 110. The bale spear bushing 170 can be centered approximately on top of the inside of attachment frame 110. In some embodiments, the bale spear bushing is configured to be releasable. In one embodiment, the bale spear bushing 170 is centered on horizontal top piece 115 and positioned inside of the attachment frame 110. The bale spear bushing 170 faces towards the front of the attachment frame (i.e., away from the tractor).

In some embodiments, the bale spear bushing 170 is connected to the horizontal top piece 115 via bale spear bushing mount 180. The bale spear bushing mount 180 may be welded onto the horizontal top piece 115. In other embodiments, the bale spear bushing mount 180 is releasably mounted on the horizontal top piece 115. In some embodiments, the bale spear bushing mount 180 is rectangular shaped (i.e., a square). The bale spear bushing mount 180 may be hollow and the end of the base spear bushing mount can be capped, such as e.g., with cap 255. In one embodiment, bale spear bushing mount 180 is centered on horizontal top piece 115 and positioned inside of the attachment frame 110 such that the bale spear bushing 170 is centered on horizontal top piece 115.

Grab hook 190 and grab hook 200 are mounted on vertical connector 130 and vertical connector 130 equidistant from each other, respectively. Grab hook 190 and grab hook 200 are positioned so that they are in line with the bale spear bushing 170 and/or bale spear bushing mount 180. Grab hook 190 and grab hook 200 are arranged so that the hooks are facing away from each other on a horizontal plane parallel along the front of the attachment frame 110, i.e., parallel to the horizontal top piece 115 and/or the horizontal bottom piece 120.

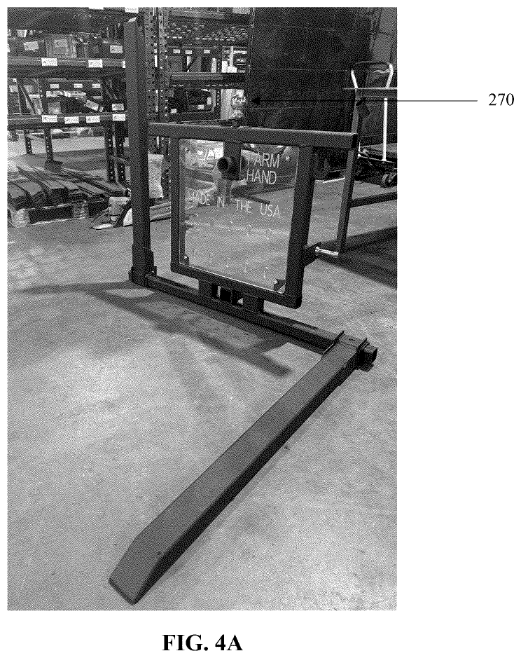

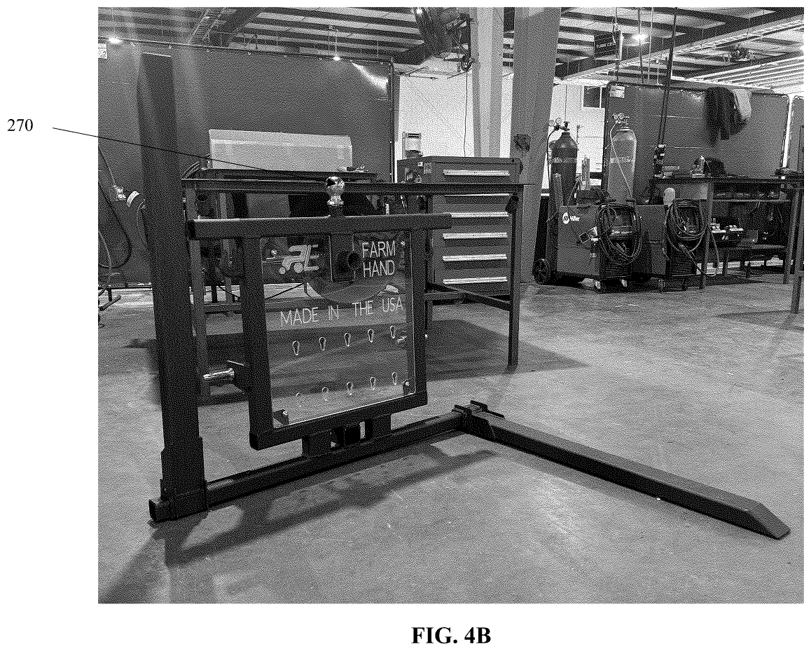

Tractor connector mount 210 and tractor connector mount 220 are attached toward the bottom of vertical connector 130 and vertical connector 130, respectively. The tractor connector mount 210 and tractor connector mount 220 are configured to connect to a convention three piece tractor mount. Tractor connector mount 210 and tractor connector mount 220 are positioned equidistant from each other on vertical connector 125 and vertical connector 130. Tractor connector mount 210 and tractor connector mount 220 are mounted on the backside of attachment frame 110 (or the backsides of vertical connector 125 and vertical connector 130) facing the tractor. In some embodiments, the tractor connector mount 210 and tractor connector mount 220 include a pin (see e.g., FIG. 4A and FIG. 4B).

The inside of attachment frame 110 can have a backplate 230 mounted in it. The backplate can contain ornamental features. The backplate 230 can be transparent and may be constructed of plexiglass and the like. The backplate 230 may also have holes toward the bottom. In certain embodiments, the backplate 230 is attached to the inside of attachment frame 110 via backplate attachment mounts 235. In some embodiments, the backplate attachment mounts touch at least two sides of the attachment frame on the inside frame.

FIG. 1B shows another front view of a multifunctional tractor equipment attachment 100 according to one embodiment of the disclosure. Specifically, FIG. 1B shows attachment frame 110 having the features described above. Also visible in FIG. 1B are front facing forks 250. The front facing forks 250 that are mounted on the fork attachment bar 150 are shown below the attachment frame 110. The each of the front facing forks 250 has a slanted end on one end and a hinge on the other end. The front facing forks 250 are configured to be mounted toward either ends on the fork attachment bar 150 such that the slanted ends of face toward the front in one position and parallel to the attachment frame 110 in the other position.

FIG. 1C shows a top perspective view of a multifunctional tractor equipment attachment 100 according to one embodiment of the disclosure. Specifically, FIG. 1C shows the horizontal top piece 115 of the multifunctional tractor equipment attachment 100 with bale spear bushing 170 mounted in center of the horizontal top piece 115 facing toward the front (away from the tractor). Upper draw pin mount 240 is also attached to the horizontal top piece 115 of the multifunctional tractor equipment attachment 100. The upper draw pin mount 240 faces to the backside (toward the tractor). The upper draw pin mount is positioned on the horizontal top piece 115 opposite to the bale spear bushing 170. Tractor connector mount 210 and tractor connector mount 220 are attached to vertical connector 125 and vertical connector 130 (not visible). Also shown in FIG. 1C is fork attachment bar 150 mounted parallel to the horizontal top piece 115.

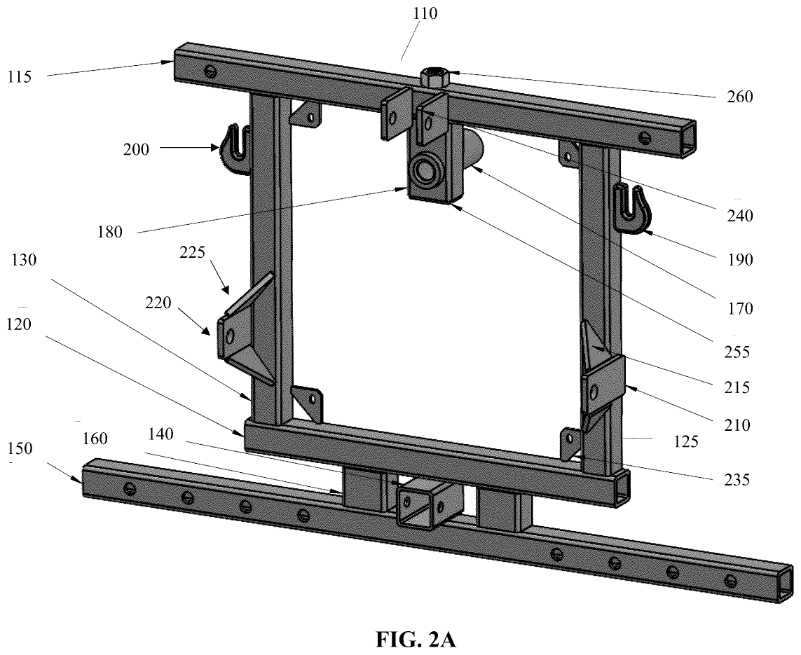

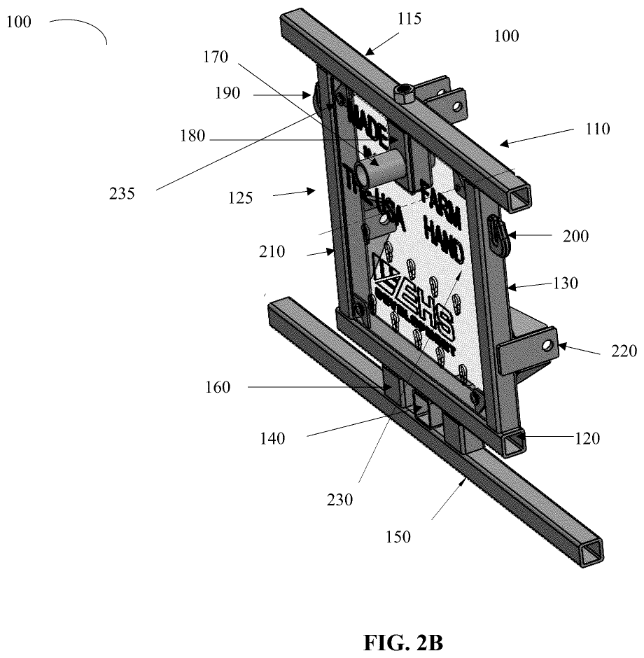

FIG. 2A shows a back view of the multifunctional tractor equipment attachment 100 without backplate 230 in place. The side of multifunctional tractor equipment attachment 100 shown in FIG. 2A is the side facing the tractor. The interior of attachment frame 110 in FIG. 2A is in the shape of square. In FIG. 2A, attachment frame 110 has horizontal top piece 115 and horizontal bottom piece 120 which are parallel to each other. The other sides of the attachment frame are vertical connector 125 and vertical connector 130 which are parallel to each other and perpendicular to the horizontal top piece 115 and horizontal bottom piece 120. Mounted on the center of horizontal top piece 115 and facing the backside is upper draw pin mount 240. Draw pin mount 240 has holes for a pin. Bale spear bushing mount 180 with forward facing bale spear bushing 170 are also mounted on the center of horizontal top piece 115 facing the interior of attachment frame 110. Bale spear bushing mount 180 is held in place by screw 260 which faces upwards. Screw 260 can be replaced with a tow ball 270. Base spear bushing mount also has cap 255. Horizontal top piece 115 has holes on either end. In some embodiments, these holes can be used to attach screws and washers for other attachment. The horizontal top piece 115 in FIG. 2A is longer than the horizontal bottom piece 120. While the interior of attachment frame 110 in FIG. 2A is square shaped, the exterior does not have to square shaped. As shown in FIG. 2A, horizontal bottom piece 120 can extend slightly beyond the vertical connector 125 and vertical connector 130. In each corner of the square shaped interior of attachment frame 110 are backplate attachment mounts 235 for howling backplate 230 (not shown). While other configurations are possible, the backplate attachment mounts 235 in FIG. 2A are configured so that each mount touches two sides of the attachment frame. Mounted toward the top of vertical connector 130 and vertical connector 125 are grab hooks 200 and 190, respectively. The grab hooks 190 and 200 are mounted on the outside of attachment frame 110, each facing an end of the horizontal top piece 115. Tractor connector mount 220 and tractor connector mount 210 are mounted toward the bottom end of vertical connector 130 and vertical connector 125, respectively. The tractor connector mount 220 and tractor connector mount 210 face toward the backside (i.e., the tractor) and are configured to be mounted to the tractor. As shown in FIG. 2A, tractor connector mount 220 and tractor connector mount 210 are attached toward the bottom end of vertical connector 130 and vertical connector 125 on the outside of the attachment frame 110, respectively.

In the embodiment shown in FIG. 2A, tractor connector mount 220 has tactor connector mount wings 225 that help with attaching the tractor connector mount 220 to the vertical connector 130. In the embodiment shown in FIG. 2A, the tactor connector mount wings 225 are triangular shaped and mounted on the backside of vertical connector 130. In the embodiment shown in FIG. 2A, tractor connector mount 210 has tactor connector mount wings 215 that help with attaching the tractor connector mount 210 to the vertical connector 125. In the embodiment shown in FIG. 2A, the tactor connector mount wings 215 are triangular shaped and mounted on the backside of vertical connector 125. Tow hitch 140 is attached to attachment frame 110. Tow hitch 140 is mounted on the outside of the attachment frame and is centered on horizontal bottom piece 120. In the embodiment shown in FIG. 2A, the two hitch 140 has holes for holding a trailer ball mount 145; the holes are on the backside of the attachment frame. Fork attachment bar 150 is mounted below tow hitch 140. Fork attachment bar is positioned parallel and horizontal bottom piece 120. Connectors 160 are mounted between the horizontal bottom piece 120 and the fork attachment bar 150. These connectors 160 strengthen the connection between the horizontal bottom piece 120 and the fork attachment bar 150. Fork attachment bar 150 has holes in it. In certain embodiments, the holes are used to attach the forks.

FIG. 2B shows the front view of the embodiment of attachment frame 110 shown in FIG. 2A above. In FIG. 2B, the backplate 230 is in place. Not visible in FIG. 2A are the holes on the fork attachment bar 150.

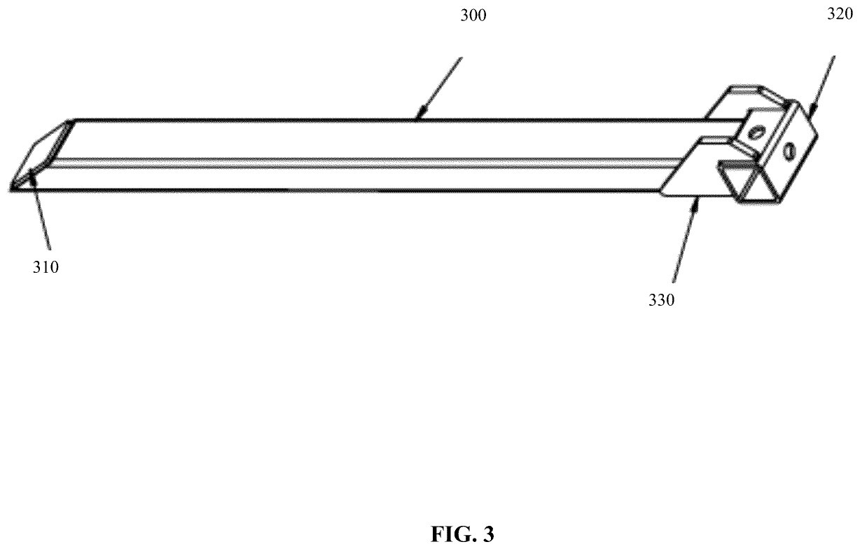

FIG. 3 shows an embodiment for a front facing fork of the disclosure. Specifically, FIG. 3 shows fork 300 having fork hinge connector 330 on one end and slanted fork end 310 on the other end. Fork hinge connector 330 connectors the fork 300 to fork hinge 320. The fork hinge 320 is connected to or attached to a fork attachment bar, such as e.g., fork attachment bar 150. As shown in FIG. 3, fork 300 is in the extended position in which the fork is horizontally facing. In the un-extended or folded position, the fork 300 is positioned vertically to the fork attachment bar (e.g., fork attachment bar 150) with the slanted fork end 310 facing upwards. Fork 300 may have a variety of different shapes. For example, as shown in FIG. 3, fork 300 may be rectangular shaped. In other embodiments, fork 300 may be tubular shaped.

FIG. 4A and FIG. 4B show a picture of multifunctional tractor equipment attachment with fork 300 attached toward either end of fork attachment bar. The multifunctional tractor equipment attachment differs slightly from the multifunctional tractor equipment attachment shown above. Specifically, in place of screw 260, a tow ball 270 is used. Otherwise, the multifunctional tractor equipment attachment has the same arrangement as discussed above. In the embodiments shown in FIG. 4A and FIG. 4B, the tractor connector mount 210 and tractor connector mount 220 have pins. As shown in FIG. 4A and FIG. 4B, in certain embodiments, the pin is held in place by a screw.

Thus, one embodiment of the disclosure is a tractor equipment attachment having a rectangular shaped attachment frame, a tow hitch receiver, a fork attachment bar, a pair of front facing forks, a bale spear bushing, an upper draw pin, a pair of grab hooks, and a pair of tractor connector mounts.

In one embodiment, the rectangular shaped attachment frame has a front side, a back side, a horizontal top piece, and a parallel horizontal bottom piece connected by vertical connectors positioned toward each end of the parallel horizontal bottom piece. In certain embodiments, the attachment frame is square shaped. The horizontal top piece can extend beyond the ends of the square. The horizontal top piece, the parallel horizontal bottom piece, and the vertical connectors may be rectangular or tubular.

In one embodiment, the tow hitch receiver is connected to the horizontal bottom piece outside the rectangular shaped attachment frame. The tow hitch receiver has a front side for receiving a ball mount and a back side. In some embodiments, the backside of the two hitch receiver includes a pair of holes for holding a pin for holding a ball mount. The holes can be positioned on the backside.

The tractor equipment attachment also includes a fork attachment bar that is connected to the tow hitch receiver and parallel to the horizontal bottom piece with front facing forks mounted on the fork attachment bar. In addition, the tractor equipment attachment includes a pair of front facing forks. Each of the front facing forks is attached towards a different end of the fork attachment bar. In some embodiments, the fork attachment bar has a connector connecting the bar and the parallel horizontal bottom piece.

The tractor equipment attachment also includes a bale spear bushing releasably mounted on approximately the middle of horizontal top piece. In certain embodiments, the bale spear bushing is positioned on the inside of the rectangular shaped attachment frame. In other embodiments, the bale spear bushing face the front side of the rectangular shaped attachment frame (i.e., away from the tractor).

In some embodiments, the upper draw pin mount faces the back side of the rectangular shaped attachment frame. The upper draw pin mount is also mounted on the horizontal top piece opposite to the bale spear.

The pair of grab hooks is mounted parallel on the vertical connectors. The pair of grab hooks is also positioned on the vertical connectors in line with the bale spear bushing. The pair of tractor connector mounts are mounted parallel on the vertical connectors facing the back side of the rectangular shaped attachment frame (i.e., facing the tractor).

In certain embodiments, the interior of the attachment frame is square shaped. In other embodiments, the bale spear bushing is mounted on the middle of the horizontal top piece via a bale spear bushing mount. In additional embodiments, the bale spear bushing mount is capped.

In some embodiments, the front facing forks are each attached to an end of the fork attachment bar. In other embodiments, the front facing forks are foldable with a closed position parallel to the vertical connectors and an open position facing the front. In other embodiments, the front facing forks are hinged.

Another embodiment of the disclosure is a multifunctional tractor equipment attachment having: a rectangular shaped attachment frame; a two hitch receiver; a fork attachment bar; a pair of forks; a bale spear bushing; an upper pin mount; a pair of grab hooks; and a pair of tractor connector mounts.

In this embodiment, the rectangular shaped attachment frame has a front side, a back side, a horizontal top piece, and a parallel horizontal bottom piece connected by parallel vertical connectors positioned toward each end of the parallel horizontal bottom piece. The tow hitch receiver is connected to the horizontal bottom piece outside the rectangular shaped attachment frame that has front side. The tow hitch receiver is also configured for receiving a ball mount and a back side. The fork attachment bar is connected to the tow hitch receiver and parallel to the horizontal bottom piece with a pair of front facing forks mounted on the bar.

The pair of forks is rotatably attached towards each end of the fork attachment bar. The bale spear bushing is releasably mounted on approximately the middle of horizontal top piece. The bale spear bushing is also positioned on the inside of the rectangular shaped attachment frame, and it faces the front side of the rectangular shaped attachment frame. The upper draw pin mount faces the back side of the rectangular shaped attachment frame, and it is mounted on the horizontal top piece opposite to the bale spear. The pair of grab hooks is mounted parallel on the vertical connectors; the pair of grab hooks are positioned on the vertical connectors in line with the bale spear bushing. The pair of tractor connector mounts is mounted parallel on the vertical connectors facing the back side of the rectangular shaped attachment frame.

In certain embodiments, the pair of forks is configured to rotate from a closed position parallel to the vertical connectors to an open position facing the front side. In some embodiments, each fork has an angled front end and a back end that is rotatably attached toward each end of the fork attachment bar. The back end of each fork is attached to the fork attachment bar via a hinge.

Each fork has an open and closed position. In the closed position, the angled front end of each fork is parallel to the vertical connectors. In the open position, the angled front end of each fork extends away from the front end of the rectangular shaped attachment frame.

The Table below lists the elements illustrated in the Figures.

| Element | Description |
|---|---|
| 100 | Multifunctional tractor equipment attachment |
| 110 | Attachment frame |
| 115 | Horizontal top piece |
| 120 | Horizonal bottom piece |
| 125 | Vertical connector |
| 130 | Vertical connector |
| 140 | Tow hitch |
| 145 | Trailer ball mount |
| 150 | Fork attachment bar |
| 160 | Connector |
| 170 | Bale spear bushing |
| 180 | Bale spear bushing mount |
| 190, 200 | Grab hooks |
| 210, 220 | Tractor Connector Mount |
| 215, 225 | Tractor Connector Mount Wings |
| 230 | Backplate |
| 235 | Backplate attachment mounts |
| 240 | Upper Draw Pin Mount |
| 250 | Front facing fork |
| 255 | Cap |
| 260 | Screw |
| 270 | Tow ball |
| 300 | Fork |
| 310 | Slanted fork end |
| 320 | Fork Hinge |
| 330 | Fork Hinge Connector |

While the invention has been described and illustrated herein by references to various specific materials, procedures, and examples, it is understood that the invention is not restricted to the particular combinations of material and procedures selected for that purpose. Numerous variations of such details can be implied as will be appreciated by those skilled in the art. It is intended that the specification and examples be considered as exemplary, only, with the true scope and spirit of the invention being indicated by the following claims. All references, patents, and patent applications referred to in this application are herein incorporated by reference in their entirety.

### Embodiments

The invention provides also the following non-limiting embodiments.

Embodiment 1 is a multifunctional tractor equipment attachment comprising: a rectangular shaped attachment frame having a front side, a back side, a horizontal top piece and a parallel horizontal bottom piece connected by vertical connectors positioned toward each end of the parallel horizontal bottom piece; a tow hitch receiver connected to the horizontal bottom piece outside the rectangular shaped attachment frame having a front side for receiving a ball mount and a back side; a fork attachment bar connected to the tow hitch receiver and parallel to the horizontal bottom piece with a pair of front facing forks mounted on the fork attachment bar, each fork attached towards a different end of the fork attachment bar; a bale spear bushing releasably mounted on approximately the middle of horizontal top piece, the bale spear bushing positioned on the inside of the rectangular shaped attachment frame and facing the front side of the rectangular shaped attachment frame; an upper draw pin mount facing the back side of the rectangular shaped attachment frame mounted on the horizontal top piece opposite to the bale spear; a pair of grab hooks mounted parallel on the vertical connectors positioned on the vertical connectors in line with the bale spear bushing; and a pair of tractor connector mounts mounted parallel on the vertical connectors facing the back side of the rectangular shaped attachment frame.

Embodiment 2 is the multifunctional tractor equipment attachment of embodiment 1 wherein the interior of the attachment frame is square shaped.

Embodiment 3 is the multifunctional tractor equipment of embodiments 1 or 2, wherein the horizontal top piece extends beyond the ends of the square.

Embodiment 4 is the multifunctional tractor equipment attachment of any one of embodiments 1 to 3, wherein the tow hitch receiver has a pair of holes for holding a pin for holding a ball mount.

Embodiment 5 is the multifunctional tractor equipment attachment of embodiment 4, wherein the holes are positioned on the backside of the tow hitch receiver.

Embodiment 6 is the multifunctional tractor equipment attachment of any one of embodiments 1 to 5, wherein the fork attachment bar has a connector connecting the bar and the parallel horizontal bottom piece.

Embodiment 7 is the multifunctional tractor equipment attachment of any one of embodiments 1 to 6, wherein the bale spear bushing is mounted on the middle of the horizontal top piece via a bale spear bushing mount.

Embodiment 8 is the multifunctional tractor equipment attachment of embodiment 7, wherein the bale spear bushing mount is capped.

Embodiment 9 is the multifunctional tractor equipment attachment of any one of embodiments 1 to 8, comprising front facing forks each attached to an end of the fork attachment bar.

Embodiment 10 is the multifunctional tractor equipment attachment of embodiment 9, wherein the front facing forks are foldable with a closed position parallel to the vertical connectors and an open position facing the front.

Embodiment 11 is the multifunctional tractor equipment attachment of embodiments 9 or 10, wherein the front facing forks are hinged.

Embodiment 12 is a multifunctional tractor equipment attachment comprising: a rectangular shaped attachment frame having a front side, a back side, a horizontal top piece and a parallel horizontal bottom piece connected by parallel vertical connectors positioned toward each end of the parallel horizontal bottom piece; a tow hitch receiver connected to the horizontal bottom piece outside the rectangular shaped attachment frame having front side configured for receiving a ball mount and a back side; a fork attachment bar connected to the tow hitch receiver and parallel to the horizontal bottom piece with a pair of front facing forks mounted on the bar, the pair of forks rotatably attached towards each end of the fork attachment bar; a bale spear bushing releasably mounted on approximately the middle of horizontal top piece, the bale spear bushing positioned on the inside of the rectangular shaped attachment frame and facing the front side of the rectangular shaped attachment frame; an upper draw pin mount facing the back side of the rectangular shaped attachment frame mounted on the horizontal top piece opposite to the bale spear; a pair of grab hooks mounted parallel on the vertical connectors positioned on the vertical connectors in line with the bale spear bushing; and a pair of tractor connector mounts mounted parallel on the vertical connectors facing the back side of the rectangular shaped attachment frame.

Embodiment 13 is the multifunctional tractor equipment attachment of embodiment 12, wherein the pair of forks is configured to rotate from a closed position parallel to the vertical connectors to an open position facing the front side.

Embodiment 14 is the multifunctional tractor equipment attachment of embodiment 12, wherein each fork has an angled front end and a back end that is rotatably attached toward each end of the fork attachment bar.

Embodiment 15 is the multifunctional tractor equipment attachment of embodiment 14, wherein the back end of each fork is attached via a hinge.

Embodiment 16 is the multifunctional tractor equipment attachment of embodiment 14, wherein in a closed position the angled front end of each fork is parallel to the vertical connectors.

Embodiment 17 is the multifunctional tractor equipment attachment of embodiment 16, wherein in an open position the angled front end of each fork extends away from the front end of the rectangular shaped attachment frame.

What is claimed is:

1. A multifunctional tractor equipment attachment comprising:
a rectangular shaped attachment frame having a front side, a back side, a horizontal top piece and a parallel horizontal bottom piece connected by vertical connectors positioned toward each end of the parallel horizontal bottom piece;
a tow hitch receiver connected to the horizontal bottom piece outside the rectangular shaped attachment frame having a front side for receiving a ball mount and a back side;
a fork attachment bar connected to the tow hitch receiver and parallel to the horizontal bottom piece with a pair of front facing forks mounted on the fork attachment bar, each fork attached towards a different end of the fork attachment bar;
a bale spear bushing releasably mounted on approximately the middle of horizontal top piece, the bale spear bushing positioned on the inside of the rectangular shaped attachment frame and facing the front side of the rectangular shaped attachment frame;
an upper draw pin mount facing the back side of the rectangular shaped attachment frame mounted on the horizontal top piece opposite to the bale spear;
a pair of grab hooks mounted parallel on the vertical connectors positioned on the vertical connectors in line with the bale spear bushing; and
a pair of tractor connector mounts mounted parallel on the vertical connectors facing the back side of the rectangular shaped attachment frame.

2. The multifunctional tractor equipment attachment of claim 1 wherein the interior of the attachment frame is square shaped.

3. The multifunctional tractor equipment of claim 1, wherein the horizontal top piece extends beyond the ends of the square.

4. The multifunctional tractor equipment attachment of claim 1, wherein the tow hitch receiver has a pair of holes for holding a pin for holding a ball mount.

5. The multifunctional tractor equipment attachment of claim 4, wherein the holes are positioned on the backside of the tow hitch receiver.

6. The multifunctional tractor equipment attachment of claim 1, wherein the fork attachment bar has a connector connecting the bar and the parallel horizontal bottom piece.

7. The multifunctional tractor equipment attachment of claim 1, wherein the bale spear bushing is mounted on the middle of the horizontal top piece via a bale spear bushing mount.

8. The multifunctional tractor equipment attachment of claim 7, wherein the bale spear bushing mount is capped.

9. The multifunctional tractor equipment attachment of claim 1, comprising front facing forks each attached to an end of the fork attachment bar.

10. The multifunctional tractor equipment attachment of claim 9, wherein the front facing forks are foldable with a closed position parallel to the vertical connectors and an open position facing the front.

11. The multifunctional tractor equipment attachment of claim 9, wherein the front facing forks are hinged.

12. A multifunctional tractor equipment attachment comprising:
a rectangular shaped attachment frame having a front side, a back side, a horizontal top piece and a parallel horizontal bottom piece connected by parallel vertical connectors positioned toward each end of the parallel horizontal bottom piece;
a tow hitch receiver connected to the horizontal bottom piece outside the rectangular shaped attachment frame having front side configured for receiving a ball mount and a back side;
a fork attachment bar connected to the tow hitch receiver and parallel to the horizontal bottom piece with a pair of front facing forks mounted on the bar, the pair of forks rotatably attached towards each end of the fork attachment bar;
a bale spear bushing releasably mounted on approximately the middle of horizontal top piece, the bale spear bushing positioned on the inside of the rectangular shaped attachment frame and facing the front side of the rectangular shaped attachment frame;
an upper draw pin mount facing the back side of the rectangular shaped attachment frame mounted on the horizontal top piece opposite to the bale spear;
a pair of grab hooks mounted parallel on the vertical connectors positioned on the vertical connectors in line with the bale spear bushing; and
a pair of tractor connector mounts mounted parallel on the vertical connectors facing the back side of the rectangular shaped attachment frame.

13. The multifunctional tractor equipment attachment of claim 12, wherein the pair of forks are configured to rotate from a closed position parallel to the vertical connectors to an open position facing the front side.

14. The multifunctional tractor equipment attachment of claim 12, wherein each fork has an angled front end and a back end that is rotatably attached toward each end of the fork attachment bar.

15. The multifunctional tractor equipment attachment of claim 14, wherein the back end of each fork is attached via a hinge.

16. The multifunctional tractor equipment attachment of claim 14, wherein in a closed position the angled front end of each fork is parallel to the vertical connectors.

17. The multifunctional tractor equipment attachment of claim 16, wherein in an open position the angled front end of each fork extends away from the front end of the rectangular shaped attachment frame.
